(19) United States
(12) Patent Application Publication
(10) Pub. No.: US 2026/0365569 A1
(43) Pub. Date: Nov. 19, 2026

(54) ENHANCED GLASS EDGE STRENGTH THROUGH STEAM TREATMENT AND LASER PROCESSING

(71) Applicant: CORNING INCORPORATED, CORNING, NY (US)

(72) Inventors: EMILY MARIE AALDENBERG, CORNING, NY (US); TIMOTHY EVAN DIMOND, CORNING, NY (US); TIMOTHY MICHAEL GROSS, PAINTED POST, NY (US); GARRETT ANDREW PIECH, CORNING, NY (US); SERGIO TSUDA, HORSEHEADS, NY (US); HEATHER NICOLE VANSELOUS, CORNING, NY (US); JINGSHI WU, PAINTED POST, NY (US)

(21) Appl. No.: 19/577,614

(22) Filed: Mar. 25, 2026

Related U.S. Application Data
(60) Provisional application No. 63/785,820, filed on Apr. 9, 2025.

(51) Int. Cl. C03C 21/00; C03C 3/097; C03C 23/00

(52) U.S. Cl. CPC C03C 21/007; C03C 3/097; C03C 23/0025

(57) ABSTRACT

Methods and glass-based articles having strengthened edges where perforations are formed in a glass-based substrate followed by a steam treatment of the perforated substrate prior to separating individual glass-based articles from the steam treated substrate. The glass-based articles are separated along contours formed by the perforations in the substrate resulting in glass-based articles having compressive stress layers extending from the edges, as well as the surfaces, having increased hydrogen concentration as well as increased resistance to damage.

### CROSS-REFERENCE TO RELATED APPLICATION

This application claims the benefit of priority under 35 U.S.C. § 119 of U.S. Provisional Application Ser. No. 63/785,820 filed on Apr. 9, 2025, the content of which is relied upon and incorporated herein by reference in its entirety.

### FIELD

This disclosure generally relates to glass-based articles having enhanced edge strength as well as methods of performing perforation and steam treatment on glass-based substrates in order to produce glass-based articles having strengthened edges.

### BACKGROUND

Glass-based articles are used in a wide variety of applications, including but not limited to smartphones, tablets, wearable devices, and the interior of automobiles. Certain applications demand that glass-based articles possess high strengths to meet various practical and regulatory requirements. Conventional processes used to increase the strength in glass-based articles may require increased resources or environmentally unfriendly materials. In addition to high strength, some applications require glass-based articles to undergo additional processing, such as the application of inks, coatings, or anti-reflection surface treatments that entail the deposition of at least one additional layer on the surface of the article. Performing such a variety of process steps can create complexities in mass production. For example, performing ion exchange strengthening as well as depositing additional layers on glass substrates individually can lead to difficulties stemming from processing and handling each individual substrate. Many articles may be damaged from such handling, leading to lower process yields.

Therefore, a need exists for glass-based materials that exhibit higher performance, such as resistance to damage, that can be produced through a more reliable process having lower cost and ease of manufacture, including a process that avoids at least some complexities associated with individualized part handling and avoids hazardous waste streams.

### SUMMARY

The present disclosure provides laser processing and steam treatment methods performed on glass-based sheets and other substrates in order to produce glass-based articles having enhanced edge strength. The disclosure is further summarized in the following paragraphs and is further characterized by combinations of any and all of the various aspects described therein.

According to aspect (1), a glass-based article is provided comprising: a first surface and a second surface, where the second surface is positioned opposite to the first surface and defines an interior comprising a glass or glass-based material; a plurality of perforations that extend in a first direction from the first surface toward the second surface and through at least a portion of the interior, wherein each perforation comprises a volume of the glass or glass-based material having a plurality of voids and/or micro-fissures, and wherein the plurality of perforations form one or more contour lines in at least one of the first and second surfaces; a first compressive layer extending from the first surface toward the second surface; a second compressive layer extending from the second surface toward the first surface; and a lateral compressive layer extending in a second direction from each of the perforations within the interior. The first, second, and lateral compressive layers each comprise an increased hydrogen concentration compared to a concentration of the interior at a midpoint between the first and second surfaces.

According to aspect (2), the glass-based article of aspect (1) is provided, wherein at least a portion of the plurality of perforations extend from the first surface to the second surface.

According to aspect (3), the glass-based article of aspect (1) or (2) is provided, wherein the one or more contour lines form a closed contour.

According to aspect (4), the glass-based article of any of aspects (1) to (3) is provided, wherein the one or more contour lines define a perimeter of a finished article.

According to aspect (5), the glass-based article of any of aspects (1) to (4) is provided, wherein the first compressive layer has a first depth of layer (DOL₁) between 5 μm and 250 μm, and the second compressive layer has a second depth of layer (DOL₂) between 5 μm and 250 μm.

According to aspect (6), the glass-based article of any of aspects (1) to (5) is provided, wherein the first compressive layer has a first depth of layer (DOL₁) between 10 μm and 150 μm, and the second compressive layer has a second depth of layer (DOL₂) between 10 μm and 150 μm.

According to aspect (7), the glass-based article of any of aspects (1) to (6) is provided, wherein the lateral compressive layer has a lateral depth of layer (DOL_{L}) between 5 μm and 250 μm.

According to aspect (8), the glass-based article of any of aspects (1) to (7) is provided, wherein the lateral compressive layer has a lateral depth of layer (DOL_{L}) between 10 μm and 150 μm.

According to aspect (9), the glass-based article of any of aspects (1) to (8) is provided, wherein the glass edge exhibits a failure stress with a B10 value greater than 200 MPa when tested for mechanical edge strength using a four-point bend test in accordance with ASTM C158-02.

According to aspect (10), the glass-based article of any of aspects (1) to (9) is provided, wherein the first compressive layer and the second compressive layer, independently from one another, exhibit a maximum compressive stress greater than or equal to 150 MPa.

According to aspect (11), the glass-based article of any of aspects (1) to (10) is provided, further comprising a coating disposed on an exterior of the first surface, second surface, or both.

According to aspect (12), the glass-based article of any of aspects (1) to (11) is provided, further comprising an ink, dielectric coating, anti-reflective layer, or polymer, disposed on an exterior of the first surface, second surface, or both.

According to aspect (13), the glass-based article of any of aspects (1) to (12) is provided, wherein perforations along the one or more contour lines are spaced apart from adjacent perforations by a distance between 1 μm and 50 μm.

According to aspect (14), the glass-based article of any of aspects (1) to (13) is provided, wherein perforations along the one or more contour lines are spaced apart from adjacent perforations by a distance between 5 μm and 30 μm.

According to aspect (15), the glass-based article of any of aspects (1) to (14) is provided, wherein the glass-based article comprises a glass-based composition comprising silicon dioxide (SiO₂), aluminum oxide (Al₂O₃), phosphorus (V) oxide (P₂O₅), or any combination thereof.

According to aspect (16), the glass-based article of any of aspects (1) to (15) is provided, wherein the glass-based article comprises a glass-based composition comprising an alkali metal oxide selected from the group consisting of lithium oxide (Li₂O), sodium oxide (Na₂O), potassium oxide (K₂O), rubidium oxide (Rb₂O), cesium oxide (Cs₂O), and any combination thereof.

According to aspect (17), the glass-based article of any of aspects (1) to (16) is provided, wherein the glass-based article comprises a glass-based composition comprising greater than or equal to 50 mol % and less than or equal to 70 mol % SiO₂; greater than or equal to 5 mol % and less than or equal to 20 mol % Al₂O₃; greater than or equal to 1 mol % and less than or equal to 9 mol % P₂O₅; greater than or equal to 1 mol % and less than or equal to 20 mol % Na₂O; and greater than or equal to 1 mol % and less than or equal to 10 mol % K₂O.

According to aspect (18), the present disclosure provides a method for forming a glass-based article comprising the steps of: a) forming a plurality of perforations in a glass-based substrate having a first surface and a second surface, wherein the second surface is positioned opposite to the first surface and defines an interior comprising a glass or glass-based material, wherein the plurality of perforations extend in a first direction from the first surface toward the second surface through at least a portion of the interior, and wherein each perforation comprises a volume of the glass or glass-based material having a plurality of voids and/or micro-fissures; and b) exposing the first and second surface and the plurality of perforations of the perforated substrate to a treatment environment having a first pressure, first water partial pressure, and first temperature, thereby forming a treated substrate having a first compressive layer extending from the first surface toward the second surface, a second compressive layer extending from the second surface toward the first surface; and a lateral compressive layer extending in a second direction from each of the plurality of perforations into the interior. The first, second and lateral compressive layers each comprise an increased hydrogen concentration compared to a concentration of the interior at a midpoint between the first and second surfaces.

According to aspect (19), the method of aspect (18), or any preceding aspect, is provided further comprising separating a glass-based article from the treated substrate along one or more contour lines formed by the plurality of perforations within the interior of the treated substrate, thereby generating edges at the one or more contour lines.

According to aspect (20), the method of aspect (19), or any preceding aspect, is provided, wherein the glass-based article is not subjected to conditions of the treatment environment after the glass-based article has been separated from the treated substrate.

According to aspect (21), the method of any of aspects (18) to (20), or any preceding aspect, is provided, further comprising polishing one or more edges of the glass-based article to remove at least 5 μm of material from the polished edge.

According to aspect (22), the method of any of aspects (18) to (21), or any preceding aspect, is provided, wherein perforations along the one or more contour lines are spaced apart from adjacent perforations by a distance between 1 μm and 50 μm.

According to aspect (23), the method of any of aspects (17) to (22), or any preceding aspect, is provided, wherein perforations along the one or more contour lines are spaced apart from adjacent perforations by a distance between 5 μm and 30 μm.

According to aspect (24), the method of any of aspects (17) to (23), or any preceding aspect, is provided, wherein forming the plurality of perforations in the glass-based substrate comprises directing a laser beam along the glass-based substrate and generating an induced absorption within the glass-based substrate, the induced absorption producing a plurality of voids and/or micro-fissures within the glass-based substrate.

According to aspect (25), the method of any of aspect (24), or any preceding aspect, is provided, wherein the laser is a pulsed laser having a repetition rate greater than or equal to 1 kHz and less than or equal to 5 MHz.

According to aspect (26), the method of any of aspects (24) to (25), or any preceding aspect, is provided, wherein the laser is a pulsed laser having a pulse duration of greater than or equal to 0.01 picosecond and less than or equal to 100 picoseconds.

According to aspect (27), the method of any of aspects (24) to (26), or any preceding aspect, is provided, wherein the laser is a pulsed laser wherein pulses of the pulsed laser beam are produced in bursts of at least two pulses separated by a duration of between 1 nanosecond and 250 nanoseconds.

According to aspect (28), the method of any of aspects (24) to (27), or any preceding aspect, is provided, wherein the laser beam used to form the perforations comprises a wavelength of approximately 1064 nm, 1030 nm, 532 nm, 530 nm, 355 nm, 343 nm, 266 nm, 215 nm, or combinations thereof.

According to aspect (29), the method of any of aspects (18) to (28), or any preceding aspect, is provided further comprising applying one or more surface treatments to the first surface, second surface, or both, after exposing the perforated substrate to the treatment environment and prior to separating the glass-based article from the treated substrate.

According to aspect (30), the method of aspect (29), or any preceding aspect, is provided wherein applying one or more surface treatments comprises depositing an ink, dielectric coating, anti-reflective layer, or polymer, on an exterior of the first surface, second surface, or both.

According to aspect (31), the method of any of aspects (18) to (30), or any preceding aspect, is provided wherein the first pressure of the treatment environment is greater or equal to 0.8 MPa and less than or equal to 9 MPa.

According to aspect (32), the method of any of aspects (18) to (31), or any preceding aspect, is provided wherein the first partial water pressure of the treatment environment is greater than or equal to 0.05 MPa and less than or equal to 22.0 MPa.

According to aspect (33), the method of any of aspects (18) to (32), or any preceding aspect, is provided wherein the first temperature of the treatment environment is greater than or equal to 200 °C and less than or equal to 300 °C.

According to aspect (34), the method of any of aspects (18) to (33), or any preceding aspect, is provided wherein the perforated substrate is exposed to the treatment environment for greater than or equal to 2 hours and less than or equal to 100 hours.

According to aspect (35), the method of any of aspects (18) to (34), or any preceding aspect, is provided wherein the treatment environment comprises a relative humidity of greater than or equal to 75%.

According to aspect (36), the method of any of aspects (18) to (35), or any preceding aspect, is provided wherein the glass edge exhibits a failure stress with a B10 value greater than 200 MPa when tested for mechanical edge strength using a four-point bend test in accordance with ASTM C158-02.

According to aspect (37), the method of any of aspects (18) to (36), or any preceding aspect, is provided wherein the first compressive layer and the second compressive layer, independently from one another, exhibit a maximum compressive stress greater than or equal to 150 MPa.

According to aspect (38), the present disclosure provides a glass-based article produced by the method of any of aspects (18) to (37), or any preceding aspect.

According to aspect (39), a glass-based article is provided comprising: a first surface and a second surface, wherein the second surface is positioned opposite to the first surface; one or more exterior edges extending between the first surface and the second surface, wherein the first and second surfaces and the one or more exterior edges define an interior comprising a glass or glass-based material; a first compressive layer extending from the first surface toward the second surface, a second compressive layer extending from the second surface toward the first surface, and a lateral compressive layer extending from the one or more exterior edges toward the interior, wherein the first, second, and lateral compressive layers each comprise an increased hydrogen concentration compared to the glass or glass-based material of the interior, and wherein the first compressive layer has a first depth of layer (DOL₁) between 5 μm and 250 μm, the second compressive layer has a second depth of layer (DOL₂) between 5 μm and 250 μm, and the lateral compressive layer has a lateral depth of layer (DOL_{L}) between 5 μm and 250 μm.

According to aspect (40), the glass-based article of aspect (39) is provided, wherein the first compressive layer has a first depth of layer (DOL₁) between 10 μm and 150 μm, the second compressive layer has a second depth of layer (DOL₂) between 10 μm and 150 μm, and the lateral compressive layer has a lateral depth of layer (DOL_{L}) between 10 μm and 150 μm.

According to aspect (41), the glass-based article of any of aspects (39) to (40) is provided, wherein at least one of the exterior edges is a polished edge and wherein the lateral compressive layer has a lateral depth of layer (DOL_{L}) that is at least 5 μm less than the first depth of layer (DOL₁) and the second depth of layer (DOL₂).

According to aspect (42), the glass-based article of any of aspects (39) to (41) is provided, wherein at least one of the exterior edges is a polished edge and wherein the lateral compressive layer has a lateral depth of layer (DOL_{L}) that is at between 5 μm to 100 μm less than the first depth of layer (DOL₁) and the second depth of layer (DOL₂).

According to aspect (43), the glass-based article of any of aspects (39) to (42) is provided, wherein the glass-based article comprises a glass-based composition comprising greater than or equal to 50 mol % and less than or equal to 70 mol % SiO₂; greater than or equal to 5 mol % and less than or equal to 20 mol % Al₂O₃; greater than or equal to 1 mol % and less than or equal to 9 mol % P₂O₅; greater than or equal to 1 mol % and less than or equal to 20 mol % Na₂O; and greater than or equal to 1 mol % and less than or equal to 10 mol % K₂O.

Additional features and advantages will be set forth in the detailed description which follows, and in part will be readily apparent to those skilled in the art from that description or recognized by practicing the aspects as described herein, including the detailed description, the claims, as well as the appended drawings.

The accompanying drawings are included to provide a further understanding of principles of the disclosure, and are incorporated in, and constitute a part of, this specification. The drawings illustrate one or more aspect(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the aspects as described herein.

### BRIEF DESCRIPTION OF THE DRAWINGS

FIG. 1 shows a side view (top) and top view (bottom) schematic of a glass-based substrate having a plurality of perforations formed through the substrate according to one or more aspects of the present disclosure.

FIG. 2 shows a cross-sectional view schematic of a glass-based articled formed from the substrate of FIG. 1 after undergoing a steam treatment and separation according to one or more aspects of the present disclosure.

FIG. 3 is a flow chart of a process of forming a glass-based article having strengthened edges by forming a plurality of perforations in a glass-based substrate to form a closed contour of the article to be formed followed by exposing the substrate to a steam treatment, according to one or more aspects of the present disclosure.

FIG. 4 shows optical microscope images of a steam strengthened glass after laser nano-perforation and before separation. Left: laser incident surface. Right: Laser exit surface.

FIG. 5 shows optical microscope images of the edge of a steam strengthened article after laser nano-perforation and manual separation. The arrow indicates the surface on which the laser was incident (i.e., parallel to plane of page).

FIG. 6 shows 4-point bend reliability results of a glass-based article with 4 different cutting approaches: 1. formation of nano-perforations followed by separation of the articles from the glass sheet (no steam treatment); 2. steam treatment, followed by formation of nano-perforations and then separation of the articles from the glass sheet; 3. formation of nano-perforations, separation of articles from the glass sheet, followed by steam treatment of individual articles; and 4. formation of nano-perforations, followed by steam treatment of entire sheet; and separation of treated articles from the glass sheet.

FIG. 7A is a top view of a glass-based article having a plurality of perforations formed through the article according to one or more aspects of the present disclosure.

FIG. 7B is a profile view of a glass-based article that has been singulated from the article of FIG. 7A.

FIG. 8 is a line graph depicting normalized intensity versus approximate depth for three measurement areas on a singulated glass-based article described in Example 3.

### DETAILED DESCRIPTION

In many conventional methods, finished or intermediate glass articles are separated from a glass-based sheet or other substrate using a mechanical score-and-break method, which is a standard glass cutting process. However, the mechanical score-and-break method does not work well for strengthened glass materials. Particularly when the central tension of the sheet is very high, the glass can fracture uncontrollably.

In previous processes where a glass sheet is strengthened, such as treatment using an ion-exchange (IOX) method, articles are typically cut from the treated sheet in one of two ways. In one approach, the glass sheet is treated using an IOX salt bath and then the treated glass sheet is cut, such as through laser cutting, to form the final glass part or parts. However, while the top and bottom surfaces of the final part are strengthened by the salt bath of the IOX process, the edges of the separated part (i.e., where the glass sheet was cut) are not strengthened since those edges were not exposed to the salt bath. In a second approach, the glass sheet is first cut to form the final part and the cut parts are then treated with the IOX salt bath. In this case both the part surfaces and part edges are exposed to the salt bath and are thus strengthened. However, such IOX treatment at the individual part level, as opposed to treating the whole sheet, can be less efficient and more costly due to the many different SKUs and fixturing needed for different part geometries. Similarly, any post-process of the parts, such as applying inks or coatings, also needs to be done on the individual part level, which involves additional costs and complexity for each step.

The present disclosure provides methods and resulting articles where perforations are formed in a glass substrate followed by a steam treatment of the glass substrate prior to separating the glass-based articles from the substrate.

In an aspect, the present disclosure describes forming perforations in the glass-based substrate prior to the steam treatment. In an aspect, laser light is focused on the surface of the glass-based substrate, which creates a modification through the thickness of the glass-based material. These modified regions (also referred to herein as “perforations” and “nano-perforations”) are spaced closely (e.g., between 1-100 μm) so that during separation, cracks connect the perforations and guide the separation of the glass substrate along the desired cut contour. To fully separate the glass along the contour, stress must be present to drive the crack and achieve separation. Such separation stress is typically applied thermally (such as with a CO₂ laser) or by mechanical bending (such as by hand). In strengthened glass, such as glass processed through steam strengthening, internal stress can optionally also be used to drive the separation.

In an aspect, the present disclosure also describes steam treatments that utilize water vapor pressure, temperature, and time to cause water molecules to penetrate into the Si—O matrix of glass-based materials, reacting with network forming cations (e.g., aluminium and/or phosphorus cations) to create hydroxyl groups or to allow a hydrogen species to penetrate into the glass-based material, which cause hydrogen enrichment and volume expansion in the water penetrated layers. The resistance to volumetric expansion imposed by the unmodified material gives rise to a compressive stress in the hydrogen enriched layer. Such compressive stress layers increase the impact resistance of the glass, particularly along the edge of the article. In contrast, compressive stress in IOX processes is formed as smaller ions such as Na⁺ diffuse out of the glass and are replaced by larger ions such as K⁺. The use of a steam treatment is a more environmentally friendly alternative to conventional ion-exchange (IOX) strengthening methods that utilize ionic salt baths in terms of raw materials (water vs. salt solution) and energy usage. After the glass substrate has undergone the steam treatment, individual parts are separated from the substrate.

Reference will now be made in detail to various aspects, examples of which are illustrated in the accompanying examples and drawings.

As used herein, the terms “glass” and “glass-based” are used in the broadest sense to include any materials or objects made wholly or partly of glass, including glass ceramics (which include a crystalline phase and a residual amorphous glass phase). Unless otherwise specified, all compositions of the glass-based materials described herein are expressed in terms of mole percent (mol %), and the constituents are provided on an oxide basis.

The term “substantially” may be utilized herein to represent the inherent degree of uncertainty that may be attributed to any quantitative or qualitative comparison, value, measurement, or other representation. This term is also utilized herein to represent the degree by which a quantitative or qualitative representation may vary from a stated reference without resulting in a change in the basic character or function of the subject matter at issue. Thus, for example, a composition that is “substantially free” of any specific component (e.g., Al2O₃, MgO, or any other component) is one in which the component is not actively added or batched into the composition, but may be present in small amounts as a contaminant (e.g., less than 1000, 500, 400, 300, 200, or 100 ppm), or, if actively added or batched, is present in an amount less than 1 wt. % (e.g., or can be specified to be less than 0.5 wt. %, 0.1 wt. %, or 0.05 wt. %.), based on total amount of the composition (moles or mass for ppm, and mass for wt. %). Similarly, for example, a surface of a glass-based substrate or article that is “substantially planar” is one in which there may be slight deviations from planarity, but the overall character and function of the surface is unaffected by such deviations for the purposes of the surface being planar.

In an aspect, glass-based articles are formed by exposing glass-based substrates to a treatment environment, where the treatment environment contains water vapor and allows a hydrogen species to penetrate the glass-based substrate and increase the hydrogen concentration compared to an otherwise identical glass-basted substrate or material that is not exposed to the treatment environment. Because a center of the article generally maintains the composition and characteristics of the original substrate prior to exposure to any treatment environment, the center of the article (i.e., a midpoint between opposing exterior surfaces) also may be used as a comparative reference point. As utilized herein, hydrogen species includes molecular water (H₂O), hydroxyl groups (—OH), hydrogen ions (H⁺), and hydronium ions (H₃O⁺). The composition of the glass-based substrates may be any composition selected to promote the interdiffusion of hydrogen species into the glass (see, for example, U.S. Pat. Nos. 11,339,084 and 11,370,696).

Without wishing to be bound by any particular theory, the layers of the glass-based articles having increased hydrogen concentration may be the result of an interdiffusion of hydrogen species for ions contained in the compositions of the glass-based substrate. Hydrogen-containing species, such as H₃O⁺, H₂O, and/or H⁺, may diffuse into the glass-based substrate to form the glass-based article. Water is able to penetrate the glass-based substrates by forming silanol groups, breaking the network structure and causing a volume expansion of the glass. Such a volume expansion may generate a compressive stress layer in the glass-based articles. The compressive stress and depth of the compressive stress layer may depend on the composition of the glass-based substrate utilized to form the glass-based article, and the water vapor treatment conditions, such as temperature, pressure, water content, and duration.

As utilized herein, the term “glass-based substrate” refers to a precursor glass-based sheet or object prior to separating one or more articles from the sheet or object. The glass-based substrate may be “treated”, i.e., exposed to the steam treatment environment or conditions so as to form one or more compressive layers in the substrate having increased hydrogen concentration compared to a hydrogen concentration of the interior of the substrate (i.e., in some aspects at a midpoint of the substrate between opposing exterior surfaces, where the midpoint is also located at least 300 μm, or at least 500 μm, or at least 1 mm, away from any perforations) that is unmodified by the steam treatment. Alternatively, the substrate may be “untreated”, i.e., the sheet or object prior to being exposed to the steam treatment environment or conditions. Similarly, the term “glass-based article” refers to an individual article or part following exposure to the steam treatment that comprises one or more compressive layers having increased hydrogen concentration compared to a hydrogen concentration of the interior of the article (i.e., in some aspects at a midpoint of the article between opposing exterior surfaces, where the midpoint is also located at least 300 μm, or at least 500 μm, or at least 1 mm, away from any perforations) that is unmodified by the steam treatment. The glass-based article may be separated from the surrounding regions in the substrate to form a final or intermediate part, or the glass-article may be unseparated from the surrounding sheet or material, such as after undergoing the steam treatment but prior to the cutting and/or separation steps.

The glass-based articles disclosed herein may exhibit a compressive stress layer without undergoing conventional IOX, thermal tempering, or lamination treatments. IOX processes produce significant waste in the form of expended molten salt baths that require costly disposal, and also are applicable to only some glass compositions. Thermal tempering requires thick glass specimens as a practical matter, as thermal tempering of thin sheets utilizes small air gap quenching processes which commonly result in scratch damage, reducing performance and yield. Additionally, it is difficult to achieve uniform compressive stress across surface and edge regions when thermal tempering thin glass sheets. Laminate processes result in exposed tensile stress regions when large sheets are cut to usable sizes, which is undesirable.

The steam treatment described herein are able to form glass-based articles having increased compressive stress and edge strength while also allowing for reduced waste and lower cost when compared to IOX treatments, as molten salts are not utilized. In an aspect, the steam treatment is also capable of strengthening thin (<2 mm) glass that would not be suitable for thermal tempering.

In an aspect, the glass-based substrate and glass-based article has a thickness of from about 50 microns (μm) to about 10 mm, from about 100 μm to about 7 mm, from about 100 μm to about 2 mm, from about 100 μm to about 1 mm, from about 0.3 mm to about 5 mm, from about 0.5 to about 4 mm, from about 1 mm to about 2 mm, or any range formed from any two of the foregoing values. In some aspects, the glass-based substrate and glass-based article has a thickness less that 2 mm.

In an aspect, a plurality of perforations is formed in a glass-based substrate, such as a glass-based sheet, prior to the substrate being exposed to the treatment environment. The perforations may be referred to, in various aspects herein, as line defects, perforations, or nano-perforations (“nPs”) in the substrate. It should be understood that while sometimes described as “holes” or “hole-like,” the perforations disclosed herein are not generally complete void spaces or through-holes, but are portions of the glass-based material which have been modified, such as by laser processing, drilling, or the like. As used herein, a “perforation” comprises a volume of the modified glass or glass-based material (relative to the unmodified glass or glass-based material) having a plurality of voids and/or micro-fissures, including but not limited to scratches, flaws, void spaces, holes, or other deformities, in the substrate which enables water molecules to travel through the perforation and penetrate into the surrounding glass-based material. For example, a perforation may contain one or more of holes near the surfaces, voids within the depth of the glass-based material, micro-sized cracks through the material, and even a change of density resulting from movement of the glass-based material.

In some aspects, at least a portion of the perforations penetrate the full depth of the substrate, i.e., from the first (top) surface to the second (bottom) surface. As a result, water molecules are able to travel through the perforations and penetrate into the glass or glass-based material adjacent to the perforations throughout the entirety of the thickness of the substrate. These modified regions of the substrate form lateral layers that are under compressive stress and form the edge regions of the articles removed from the substrate, resulting in improved edge strength over articles cut from a substrate that was exposed to the steam treatment without perforations being present.

Additionally, the perforations form one or more contour lines in the substrate and enable controlled separation of material of the substrate along the one or more contour lines. As used herein, the term “contour line,” refers to a line, including a curved line, straight line, or a line having both straight and curved portions, on the surface of the substrate where portions of the substrate are to be separated from one another. In an aspect, the regions of the substrate along the contour lines have a reduced separation stress compared to an otherwise identical region of the substrate without a contour line, allowing the substrate to be preferentially cracked or broken along the contour line. The term “closed contour line,” as used herein, denotes a particular contour line that extends along a closed pathway on the surface of a substrate. As used herein, the term “contour” refers to a plurality of perforations introduced into the substrate, and the term “closed contour” refers to a contour that is formed along a closed contour line.

In some aspects, the contour lines form a closed contour and/or define a perimeter of a glass-based article to be separated from the substrate. The physical separation of the article from the substrate occurs when a crack fully propagates along the one or more contours, and may be accomplished by additional processing, such as by laser processing, including but not limited to a carbon dioxide laser to apply thermal stress, application of mechanical bending stress, use of steam treatment, or combinations thereof, to create stress in the glass, or other separation processes.

The perforations can be made by any suitable method including, for example, laser-based methods, drilling (e.g., mechanical drilling), or any combination thereof. Laser-based methods used for the processing, machining, and separation of glass-based articles are generally known in the field (such as described in U.S. Pat. Nos. 10,421,683, 10,442,719, and 10,597,321). According to one aspect, the perforations are formed in the substrate using a laser, such as a pulsed laser or a continuous wave laser. For example, a beam source outputs a pulsed laser beam, which is directed into the surface of the substrate to create a series of perforations in the substrate, thereby laser forming the one or more closed contours, where each closed contour defines a perimeter of an article to be separated from the substrate. In aspects, the pulsed laser comprises a single pulse or multiple pulses.

Suitable laser wavelengths for forming perforations are wavelengths at which the combined losses of linear absorption and scattering by the substrate are sufficiently low. In aspects, the wavelength of the laser is chosen such that the substrate is substantially transparent at this wavelength. As used herein, the term “substantially transparent” refers to a material having a linear optical absorption and scattering of less than 20% per mm of material depth for the specified pulsed laser wavelength. In aspects, the combined losses due to linear absorption and scattering by the substrate at the laser wavelength are less than 20%/mm, or less than 15%/mm, or less than 10%/mm, or less than 5%/mm, or less than 1%/mm, or any range formed from any two of the foregoing values, where the dimension “/mm” means per millimeter of distance within the substrate in the beam propagation direction of the pulsed laser beam.

In an aspect, the laser beam used to form the perforations comprises a wavelength between 100 nm and 2,000 nm, such as between 120 nm and 1,800 nm, between 150 nm and 1,600 nm, between 200 nm and 1,500 nm, between 200 nm and 1,200 nm, between 210 nm and 1,100 nm, or any range formed from any two of the foregoing values, provided that the wavelength satisfies the combined linear absorption and scattering loss requirement for a given substrate material. For example, the laser may have a wavelength of approximately 1064 nm, 1030 nm, 532 nm, 530 nm, 355 nm, 343 nm, or 266 nm, or 215 nm. Representative wavelengths for many glass materials include fundamental and harmonic wavelengths of Nd³⁺ (e.g. Nd³⁺:YAG or Nd³⁺:YVO₄ having fundamental wavelength near 1064 nm and higher order harmonic wavelengths near 532 nm, 355 nm, and 266 nm). Other wavelengths in the ultraviolet, visible, and infrared portions of the spectrum that satisfy the combined linear absorption and scattering loss requirement for a given substrate material can also be used.

The laser beam used to form the perforations may include, but is not limited to, Gaussian beams, Gauss-Bessel beams, Bessel beams, quasi-non-diffracting beams, and non-axisymmetric quasi-non diffracting beams (see, for example, U.S. Pat. No. 10,730,783), and Kerr-effect focused beams. Where the laser beam is a pulsed laser beam, the pulse duration of the individual pulses is in a range of from about 0.01 picoseconds to about 200 picoseconds, from about 0.1 picosecond to about 100 picoseconds, 1 picoseconds to about 50 picoseconds, or 5 picoseconds to 20 picoseconds, or any range formed from any two of the foregoing values. Optionally, the repetition rate of the individual pulses may be in a range from about 1 kHz to 5 MHz, from about 5 kHz to about 4 MHz, or from about 10 kHz to about 650 kHz, or any range formed from any two of the foregoing values. In an aspect, pulses of the pulsed laser beam are produced in bursts of at least two pulses separated by a duration of between 1 nanosecond and 250 nanoseconds, between 1 nanosecond and 150 nanoseconds, between 1 nanosecond and 50 nanoseconds, between 5 nanoseconds and 30 nanoseconds, or between 10 nanoseconds and 20 nanoseconds, or any range formed from any two of the foregoing values.

In an aspect, perforations along the one or more contour lines are spaced apart from an adjacent perforation by a distance between 0.1 μm and 500 μm, between 0.5 μm and 200 μm, between 1 μm and 100 μm, between 1 μm and 70 μm, between 1 μm and 60 μm, between 1 μm and 50 μm, between 10 μm and 50 μm, between 2 μm and 40 μm, or between 5 μm and 30 μm, or any range formed from any two of the foregoing values. In some aspects, a spacing between adjacent perforations is between 1 μm and 70 μm, between 1 μm and 60 μm, between 1 μm and 50 μm, 1 μm and 45 μm, 1 μm and 40 μm, 1 μm and 35 μm, 1 μm and 30 μm, 1 μm and 25 μm, 1 μm and 20 μm, 1 μm and 15 μm, or 1 μm and 10 μm, or any range formed from any two of the foregoing values.

After formation of the perforations, in some aspects articles are not immediately separated from the substrate, but instead the whole substrate or large portions of the substrate undergo additional processing, such as the steam treatment and optionally the deposition of a coating or a layer of material on an exterior surface of the unseparated articles. For example, the areas of the substrate outlined by the contour lines remain engaged (e.g., frictionally and/or bonded as part of the glass network, etc.) with one another and the rest of the substrate, allowing for additional processing of the substrate and the unseparated articles as a single unit. Examples of coatings or layers able to be deposited on one or more areas of the unseparated articles after the steam treatment has been performed include, but are not limited to, decorative ink layers, anti-reflective coatings, polymer coatings, easy-to-clean layers, and combinations thereof. Alternatively or additionally, a surface of one or more of the unseparated articles may be physically modified, such as through polishing or cleaning. The ability to perform additional processing on the unseparated articles as a single unit eliminates costly and laborious individual part handling.

The glass-based articles are produced from the perforated substrate by exposing the surfaces and the plurality of perforations of the substrate to a treatment environment containing water vapor under appropriate conditions (including but not limited to pressure and temperature). The exposure of the treatment environment may be carried out in any appropriate device, such as a furnace with relative humidity control, or other suitable chamber. In some aspects, the perforated substrate is exposed to a treatment environment having a relative humidity of greater than or equal to 75%, greater than or equal to 80%, greater than or equal to 85%, greater than or equal to 90%, greater than or equal to 95%, greater than or equal to 99%, or more, or any range formed from any two of the foregoing values. In some aspects, the glass-based substrate is exposed to an environment with 100% relative humidity.

In some aspects, the perforated substrate is exposed to a treatment environment having a temperature greater than or equal to 70 °C, greater than or equal to 75 °C, greater than or equal to 80 °C, greater than or equal to 85 °C, greater than or equal to 90 °C, greater than or equal to 95 °C, greater than or equal to 100 °C, greater than or equal to 105 °C, greater than or equal to 110 °C, greater than or equal to 115 °C, greater than or equal to 120 °C, greater than or equal to 125 °C, greater than or equal to 130 °C, greater than or equal to 135 °C, greater than or equal to 140 °C, greater than or equal to 145 °C, greater than or equal to 150 °C, greater than or equal to 155 °C, greater than or equal to 160 °C, greater than or equal to 160 °C, greater than or equal to 165 °C, greater than or equal to 170 °C, greater than or equal to 175 °C, greater than or equal to 180 °C, greater than or equal to 185 °C, greater than or equal to 190 °C, greater than or equal to 195 °C, greater than or equal to 200 °C, greater than or equal to 250 °C or more, or any range formed from any two of the foregoing values, and in some aspects less than any of the upper limits set forth in the next paragraph. In some aspects, the perforated substrate is exposed to an environment at a temperature from greater than or equal to 75 °C to less than or equal to 500 °C, such as from greater than or equal to 90 °C to less than or equal to 450 °C, from greater than or equal to 100 °C to less than or equal to 400 °C, from greater than or equal to 150 °C to less than or equal to 350 °C, from greater than or equal to 200 °C to less than or equal to 300 °C, or any range formed from any two of the foregoing values.

In some aspects, the perforated substrate is exposed to a treatment environment having a pressure greater than or equal to 0.1 MPa, greater than or equal to 0.2 MPa, greater than or equal to 0.4 MPa, greater than or equal to 0.6 MPa, greater than or equal to 0.8 MPa, greater than or equal to 1.0 MPa, greater than or equal to 1.25 MPa, greater than or equal to 1.5 MPa, greater than or equal to 2.0 MPa, greater than or equal to 2.5 MPa, greater than or equal to 3.0 MPa, greater than or equal to 4.0 MPa, greater than or equal to 5.0 MPa, greater than or equal to 6.0 MPa, greater than or equal to 7.0 MPa, greater than or equal to 8.0 MPa, greater than or equal to 9.0 MPa, greater than or equal to 10.0 MPa, greater than or equal to 15.0 MPa, or more, or any range formed from any two of the foregoing values.

In some aspects, the perforated substrate is exposed to a treatment environment having a pressure from greater than or equal to 0.1 MPa to less than or equal to 25 MPa, from greater than or equal to 0.2 MPa to less than or equal to 20 MPa, from greater than or equal to 0.3 MPa to less than or equal to 15 MPa, from greater than or equal to 0.5 MPa to less than or equal to 10 MPa, from greater than or equal to 0.8 MPa to less than or equal to 9 MPa, from greater than or equal to 1.0 MPa to less than or equal to 8 MPa, from greater than or equal to 1.5 MPa to less than or equal to 6 MPa, from greater than or equal to 2.0 MPa to less than or equal to 5.0 MPa, or any range formed from any two of the foregoing values. In some aspects, the perforated substrate is exposed to an environment at ambient pressure, such as 0.1 MPa.

In some aspects, the perforated substrate is exposed to a treatment environment having a water partial pressure greater than or equal to 0.05 MPa, greater than or equal to 0.075 MPa, greater than or equal to 0.1 MPa, greater than or equal to 0.2 MPa, greater than or equal to 0.5 MPa, greater than or equal to 1.0 MPa, greater than or equal to 1.5 MPa, greater than or equal to 2.0 MPa, greater than or equal to 2.5 MPa, greater than or equal to 3.0 MPa, greater than or equal to 3.5 MPa, greater than or equal to 4.0 MPa, greater than or equal to 5.0 MPa, greater than or equal to 6.0 MPa, greater than or equal to 7.0 MPa, greater than or equal to 8.0 MPa, greater than or equal to 9.0 MPa, greater than or equal to 10.0 MPa, greater than or equal to 12.0 MPa, greater than or equal to 14.0 MPa, greater than or equal to 16.0 MPa, greater than or equal to 18.0 MPa, greater than or equal to 20.0 MPa, greater than or equal to 22.0 MPa, or more, or any range formed from any two of the foregoing values

In some aspects, the perforated substrate is exposed to a treatment environment having a water partial pressure from greater than or equal to 0.05 MPa to less than or equal to 22 MPa, such as from greater than or equal to 0.075 MPa to less than or equal to 22 MPa, from greater than or equal to 0.1 MPa to less than or equal to 20 MPa, from greater than or equal to 0.2 MPa to less than or equal to 18 MPa, from greater than or equal to 0.5 MPa to less than or equal to 16 MPa, from greater than or equal to 1.0 MPa to less than or equal to 14 MPa, from greater than or equal to 1.5 MPa to less than or equal to 12 MPa, from greater than or equal to 2.0 MPa to less than or equal to 10 MPa, from greater than or equal to 2.5 MPa to less than or equal to 8 MPa, from greater than or equal to 3.0 MPa to less than or equal to 6 MPa, or any range formed from any two of the foregoing values.

The perforated substrate is exposed to the treatment environment for a time period sufficient to produce the desired degree of hydrogen concentration in the desired compressive layers. In some aspects, the perforated substrate is exposed to the treatment environment for greater than or equal to 1 hour, greater than or equal to 2 hours, greater than or equal to 4 hours, greater than or equal to 6 hours, greater than or equal to 8 hours, greater than or equal to 10 hours, greater than or equal to 12 hours, greater than or equal to 16 hours, greater than or equal to 20 hours, greater than or equal to 24 hours, greater than or equal to 30 hours, greater than or equal to 36 hours, greater than or equal to 48 hours, greater than or equal to 60 hours, greater than or equal to 72 hours, greater than or equal to 84 hours, greater than or equal to 96 hours, greater than or equal to 108 hours, greater than or equal to 120 hours, greater than or equal to 132 hours, greater than or equal to 144 hours, greater than or equal to 156 hours, greater than or equal to 168 hours, greater than or equal to 8 days, greater than or equal to 10 days, or more, or any range formed from any two of the foregoing values.

In some aspects, the perforated substrate is exposed to the treatment environment for a time period from greater than or equal to 1 hours to less than or equal to 10 days, greater than or equal to 1.5 hours to less than or equal to 5 days, greater than or equal to 2 hours to less than or equal to 100 hours, from greater than or equal to 3 hours to less than or equal to 80 hours, from greater than or equal to 4 hours to less than or equal to 75 hours, from greater than or equal to 5 hours to less than or equal to 60 hours, from greater than or equal to 6 hours to less than or equal to 50 hours, from greater than or equal to 8 hours to less than or equal to 40 hours, from greater than or equal to 10 hours to less than or equal to 36 hours, from greater than or equal to 12 hours to less than or equal to 24 hours, or any range formed from any two of the foregoing values.

In some aspects, the perforated substrate is exposed to multiple treatment environments. In aspects, the perforated substrate is exposed to a first environment to form a first glass-based article that is then be exposed to a second treatment environment to form a second glass-based article. The first treatment environment has a first pressure, a first water partial pressure, and a first temperature, and the perforated substrate is exposed to the first environment for a first time period. The second treatment environment has a second pressure, a second water partial pressure, and a second temperature, and the first glass-based article is exposed to the second environment for a second time period to produce a second glass-based article. The first and second treatment environments, independently from one another, have a pressure, water partial pressure, temperature, and time period of exposure as described elsewhere herein. The second treatment environment may be the same or different than the first treatment environment. Optionally, the first glass article is cooled to ambient temperature before being exposed to the second treatment environment. Third, fourth, fifth, and so on, treatment environments are also contemplated and can be the same or different from the first treatment environment.

After the steam treatment and optional additional surface treatments, the one or more articles are separated from the substrate or sheet using any suitable technique known in the art, such as by use of mechanical force and/or cutting (e.g., laser cutting and/or mechanical cutting, etc.). The separated articles have strengthened surfaces and edge regions having increased hydrogen concentration compared to otherwise identical glass or glass-based materials not exposed to the steam treatment.

Additionally, in an aspect, polishing the edges of the articles after separation results in additional improved edge strength. Such polishing steps remove a portion of the compressive layer formed by the steam treatment, resulting in the edge layer of the article having a diminished depth of layer. However, the polishing step also removes flaws (e.g., chips and cracks or subsurface damage from the laser process itself) in the edge close to the surface, thereby improving the edge strength. In some aspects, polishing the edges removes at least 5 μm of material, at least 10 μm of material, at least 15 μm of material, at least 20 μm of material, at least 25 μm of material, at least 30 μm of material, at least 53 μm of material, at least 40 μm of material, at least 45 μm of material, at least 50 μm of material, at least 60 μm of material, at least 70 μm of material, at least 80 μm of material, at least 90 μm of material, at least 100 μm of material, at least 110 μm of material, at least 120 μm of material, at least 130 μm of material, at least 140 μm of material, or optionally up to the depth-of-layer of the treated material, or any range formed from any two of the foregoing values, from the edge. In some aspects, polishing the edges removes between 5 μm and 150 μm of material, between 5 μm and 140 μm of material, between 5 μm and 120 μm of material, between 5 μm and 100 μm of material, between 5 μm and 80 μm of material, between 5 μm and 60 μm of material, between 5 μm and 40 μm of material, or between 5 μm and 20 μm of material or any range formed from any two of the foregoing values.

The glass-based articles disclosed herein comprise one or more compressive layers extending from a surface or edge of the article to a depth of layer (DOL). The compressive layer has a hydrogen concentration that decreases from a maximum hydrogen concentration of the glass-based article to a hydrogen concentration equal to the interior of the article (i.e., the center of the article containing unmodified regions of the glass or glass-based material).

In some aspects, the glass-based article comprises a compressive layer extending from one or more exterior surfaces exposed to the treatment environment toward the interior of the article. Additionally, the article will comprise a lateral compressive layer extending in from each of the perforations within the interior of the article. The compressive layers have an increased hydrogen concentration compared to a hydrogen concentration of the interior of the article (i.e., at the center of the article containing unmodified regions of the glass-based material). In aspects, each compression layer has an increased hydrogen concentration compared to a concentration of the interior at a midpoint between the first and second surfaces at a midpoint of the substrate between opposing exterior surfaces where the midpoint is also located at least 300 μm, or at least 500 μm, or at least 1 mm, away from any perforations.

The resulting articles and/or glass edges exhibit a failure stress with a B10 value that is greater than or equal to 25 MPa when tested for mechanical edge strength using a four-point bend test in accordance with ASTM C158-02 such as greater than 50 MPa, greater than 75 MPa, greater than 100 MPa, greater than 150 MPa, greater than 200 MPa, greater than 250 MPa, greater than 300 MPa, greater than 350 MPa, greater than 400 MPa, greater than 450 MPa, greater than 500 MPa, greater than 600 MPa, greater than 700 MPa, greater than 800 MPa, or any range formed from any two of the foregoing values. As used herein, “B10” is the stress value above which at least 10% of the tested parts have failed. Optionally, the resulting articles and/or glass edges described herein exhibit a failure stress with a B10 value between 50 MPa and 1,000 MPa when tested for mechanical edge strength using a four-point bend test, in accordance with ASTM C158-02, optionally between 100 MPa and 800 MPa, between 150 MPa and 700 MPa, between 175 MPa and 600 MPa, between 180 MPa and 550 MPa, between 200 MPa and 500 MPa, between 200 MPa and 450 MPa, between 200 MPa and 430 MPa, or between 250 MPa and 400 MPa, or any range formed from any two of the foregoing values.

In an aspect, the resulting articles and/or compressive layers described herein exhibit a maximum compressive stress greater than 50 MPa, such as greater than 100 MPa, greater than 150 MPa, greater than 175 MPa, greater than 200 MPa, greater than 250 MPa, greater than 300 MPa, greater than 350 MPa, greater than 400 MPa, greater than 500 MPa, greater than 600 MPa, greater than 700 MPa, greater than 800 MPa, greater than 900 MPa, greater than 1000 MPa, greater than 1200 MPa, or any range formed from any two of the foregoing values. In an aspect, the one or more compressive layers extending from the exterior surfaces of the glass article exposed to the treatment environment exhibit, independently from one another, a maximum compressive stress between 50 MPa and 1,000 MPa, optionally between 100 MPa and 800 MPa, between 125 MPa and 700 MPa, between 150 MPa and 600 MPa, between 175 MPa and 500 MPa, between 200 MPa and 450 MPa, or between 225 MPa and 450 MPa, or any range formed from any two of the foregoing values. Additionally, in an aspect, the lateral compressive layer extending from the profusions in the article independently exhibit a maximum compressive stress between 50 MPa and 1,000 MPa, optionally between 100 MPa and 800 MPa, between 125 MPa and 700 MPa, between 150 MPa and 600 MPa, between 175 MPa and 500 MPa, between 200 MPa and 450 MPa, or between 225 MPa and 450 MPa, or any range formed from any two of the foregoing values. As used herein, surface compressive stress is measured with a surface stress meter (FSM) such as the FSM-6000, as manufactured by Orihara Industrial Co., Ltd. (Japan). Surface compressive stress measurements rely upon the measurement of the stress optical coefficient (SOC), which is related to the birefringence of the glass article. SOC, in turn, is measured according to Procedure C (Glass Disc Method) described in ASTM standard C770-16, entitled “Standard Test Method for Measurement of Glass Stress-Optical Coefficient,” the contents of which are incorporated herein by reference in their entirety. The values reported for surface compressive stress herein refer to the peak surface compressive stress, unless otherwise indicated.

In an aspect, the one or more compressive layers extending from the exterior surfaces of the glass article and the lateral compressive layer have, independently from one another, a depth of layer (DOL) greater than or equal to 1 μm, greater than or equal to 5 μm, greater than or equal to 10 μm, greater than or equal to 15 μm, greater than or equal to 20 μm, greater than or equal to 25 μm, greater than or equal to 30 μm, greater than or equal to 40 μm, greater than or equal to 50 μm, greater than or equal to 60 μm, greater than or equal to 70 μm, greater than or equal to 80 μm, greater than or equal to 90 μm, greater than or equal to 100 μm, greater than or equal to 150 μm, or more, or any range formed from any two of the foregoing values. In some aspects, the compressive layers have, independently of one another, a depth of layer (DOL) from greater than 1 μm to less than or equal to 300 μm, greater than 1 μm to less than or equal to 300 μm, greater than 1 μm to less than or equal to 200 μm, greater than 1 μm to less than or equal to 100 μm, greater than 1 μm to less than or equal to 50 μm, greater than 5 μm to less than or equal to 300 μm, greater than or equal to 5 μm to less than or equal to 250 μm, from greater than or equal to 5 μm to less than or equal to 200 μm, from greater than or equal to 5 μm to less than or equal to 150 μm, from greater than or equal to 5 μm to less than or equal to 100 μm, from greater than or equal to 5 μm to less than or equal to 50 μm, from greater than or equal to 5 μm to less than or equal to 45 μm, from greater than or equal to 5 μm to less than or equal to 20 μm, from greater than or equal to 10 μm to less than or equal to 150 μm, from greater than or equal to 10 μm to less than or equal to 100 μm, from greater than or equal to 10 μm to less than or equal to 50 μm, from greater than or equal to 10 μm to less than or equal to 45 μm, or any range formed from any two of the foregoing values. In some aspects, the DOLs (μm) are independently 1-100, 1-50, 1-40, 5-50, 5-40, 10-30, or 15-40.

The depth of layer (DOL) and hydrogen concentration of a glass-article may be measured by secondary ion mass spectrometry (SIMS) techniques as known in the art. The SIMS technique is capable of measuring the hydrogen concentration at a given depth but is not capable of distinguishing the hydrogen species present in the glass-based article. For this reason, all hydrogen species contribute to the SIMS measured hydrogen concentration. As utilized herein, the “depth of layer” or “DOL” refers to the depth within the interior of the glass-based article from an exterior surface of the glass-based article or from one or more of the perforations where the hydrogen concentration is equal to the hydrogen concentration at the center of the glass-based article (i.e., the glass-based material that has not been modified by the treatment environment). This definition accounts for the hydrogen concentration of the glass-based substrate prior to treatment, such that the depth of layer refers to the depth of the hydrogen added by the treatment process. As a practical matter, the hydrogen concentration at the center of the glass-based article may be approximated by the hydrogen concentration at the depth from the surface of the glass-based article where the hydrogen concentration becomes substantially constant, as the hydrogen concentration is not expected to change between such a depth and the center of the glass-based article. This approximation allows for the determination of the DOL without measuring the hydrogen concentration throughout the entire depth of the glass-based article. The presence of a layer having increased hydrogen concentration may be indicated by the formation of a compressive stress layer in the glass-based article as a result of the steam treatment.

The substrates and articles used herein may be formed from glass-based materials having any appropriate composition known in the art and able to promote the diffusion of hydrogen-containing species into the material as a result of the steam treatment. In an aspect, the glass-based material has a composition that includes SiO₂, AI₂O₃, P₂O₅, and combinations thereof.

In some aspects, the glass-based substrate comprises SiO₂ in an amount from greater than or equal to 45 mol % to less than or equal to 75 mol %, such as from greater than or equal to 46 mol % to less than or equal to 74 mol %, from greater than or equal to 47 mol % to less than or equal to 73 mol %, from greater than or equal to 48 mol % to less than or equal to 72 mol %, from greater than or equal to 49 mol % to less than or equal to 71 mol %, from greater than or equal to 50 mol % to less than or equal to 70 mol %, from greater than or equal to 51 mol % to less than or equal to 69 mol %, from greater than or equal to 52 mol % to less than or equal to 68 mol %, from greater than or equal to 53 mol % to less than or equal to 67 mol %, from greater than or equal to 54 mol % to less than or equal to 66 mol %, from greater than or equal to 55 mol % to less than or equal to 65 mol %, from greater than or equal to 56 mol % to less than or equal to 64 mol %, from greater than or equal to 57 mol % to less than or equal to 63 mol %, from greater than or equal to 58 mol % to less than or equal to 62 mol %, from greater than or equal to 59 mol % to less than or equal to 61 mol %, 60 mol %, or any range formed from any two of the foregoing values.

In some aspects, the glass-based substrate comprises AI₂O₃ in an amount of from greater than or equal to 3 mol % to less than or equal to 25 mol %, such as from greater than or equal to 4 mol % to less than or equal to 22 mol %, from greater than or equal to 5 mol % to less than or equal to 20 mol %, from greater than or equal to 6 mol % to less than or equal to 18 mol %, from greater than or equal to 7 mol % to less than or equal to 17 mol %, from greater than or equal to 8 mol % to less than or equal to 16 mol %, from greater than or equal to 9 mol % to less than or equal to 15 mol %, from greater than or equal to 10 mol % to less than or equal to 12 mol %, or any range formed from any two of the foregoing values.

In aspects, the glass-based substrate comprises P₂O₅ in an amount of from greater than or equal to 0.5 mol % to less than or equal to 15 mol %, such as from greater than or equal to 0.75 mol % to less than or equal to 10 mol %, from greater than or equal to 1 mol % to less than or equal to 9 mol %, from greater than or equal to 1.5 mol % to less than or equal to 8 mol %, from greater than or equal to 2 mol % to less than or equal to 7 mol %, from greater than or equal to 3 mol % to less than or equal to 6 mol %, or any range formed from any two of the foregoing values.

Optionally, the glass-based substrates may additionally include an alkali metal oxide, such as at least one of Li₂O, Na₂O, K₂O, Rb₂O, and Cs₂O, or any combination thereof. In some aspects, the glass-based substrates may be substantially free, or free, of alkali metal oxide. In some aspects, the glass composition comprises a total alkali metal oxide in an amount from greater than or equal to 0.0 mol % to less than or equal to 30.0 mol %, from greater than or equal to 0.5 mol % to less than or equal to 30.0 mol %, from greater than or equal to 1.0 mol % to less than or equal to 30.0 mol %, from greater than or equal to 1.5 mol % to less than or equal to 25.0 mol %, from greater than or equal to 2.0 mol % to less than or equal to 20.0 mol %, from greater than or equal to 2.5 mol % to less than or equal to 15.0 mol %, from greater than or equal to 3.0 mol % to less than or equal to 10.0 mol %, from greater than or equal to 3.5 mol % to less than or equal to 13.0 mol %, from greater than or equal to about 4.0 mol % to less than or equal to 12.0 mol %, from greater than or equal to 5.0 mol % to less than or equal to 10.0 mol %, from greater than or equal to 0.0 mol % to less than or equal to 10.0 mol %, from greater than or equal to 0.0 mol % to less than or equal to 8.0 mol %, from greater than or equal to 0.0 mol % to less than or equal to 6.0 mol %, from greater than or equal to 0.0 mol % to less than or equal to 4.0 mol %, from greater than or equal to 0.0 mol % to less than or equal to 2.0 mol %, or any range formed from any two of the foregoing values.

In some aspects, the glass-based substrate comprises Li₂O in an amount of from greater than or equal to 0.0 mol % to less than or equal to 5.0 mol % or from greater than or equal to 0.1 mol % to less than or equal to 5.0 mol %, such as from greater than or equal to 0.5 mol % to less than or equal to 4.9 mol %, from greater than or equal to 1.0 mol % to less than or equal to 4.8 mol %, from greater than or equal to 1.5 mol % to less than or equal to 4.7 mol %, from greater than or equal to 2.0 mol % to less than or equal to 4.6 mol %, from greater than or equal to 2.5 mol % to less than or equal to 4.5 mol %, from greater than or equal to 3.0 mol % to less than or equal to 4.0 mol %, or any range formed from any two of the foregoing values. Optionally, the glass-based substrate is substantially free or free of Li₂O.

In some aspects, the glass-based substrate comprises K₂O in an amount of from greater than or equal to 0.0 mol % to less than or equal to 20.0 mol % or from greater than or equal to 0.1 mol % to less than or equal to 20.0 mol %, such as from greater than or equal to 0.5 mol % to less than or equal to 15.0 mol %, from greater than or equal to 0.75 mol % to less than or equal to 12.0 mol %, from greater than or equal to 1.0 mol % to less than or equal to 10.0 mol %, from greater than or equal to 1.5 mol % to less than or equal to 8.0 mol %, from greater than or equal to 2.0 mol % to less than or equal to 6.0 mol %, from greater than or equal to 3.0 mol % to less than or equal to 5.0 mol %, or any range formed from any two of the foregoing values.

In some aspects, the glass-based substrate comprises Na₂O in an amount of from greater than or equal to 0 mol % to less than or equal to 11.0 mol %, such as from greater than or equal to 0.5 mol % to less than or equal to 10.5 mol %, from greater than or equal to 1.0 mol % to less than or equal to 9.0 mol %, from greater than or equal to 1.5 mol % to less than or equal to 8.5 mol %, from greater than or equal to 2.0 mol % to less than or equal to 8.0 mol %, from greater than or equal to 2.5 mol % to less than or equal to 7.5 mol %, from greater than or equal to 3.0 mol % to less than or equal to 7.0 mol %, from greater than or equal to 3.5 mol % to less than or equal to 6.5 mol %, from greater than or equal to 4.0 mol % to less than or equal to 6.0 mol %, from greater than or equal to 4.5 mol % to less than or equal to 5.5 mol %, from greater than or equal to 4.0 mol % to less than or equal to 5.0 mol %, or any range formed from any two of the foregoing values. Optionally, the glass-based substrate is substantially free or free of Na₂O.

In some aspects, the glass-based substrate comprises Rb₂O in an amount of from greater than or equal to 0 mol % to less than or equal to 10 mol %, such as from greater than or equal to 1 mol % to less than or equal to 9 mol %, from greater than or equal to 2 mol % to less than or equal to 8 mol %, from greater than or equal to 3 mol % to less than or equal to 7 mol %, from greater than or equal to 4 mol % to less than or equal to 6 mol %, 5 mol %, or any range formed from any two of the foregoing values.

In some aspects, the glass-based substrate comprises CS₂O in an amount of from greater than or equal to 0 mol % to less than or equal to 10 mol %, such as from greater than or equal to 1 mol % to less than or equal to 9 mol %, from greater than or equal to 2 mol % to less than or equal to 8 mol %, from greater than or equal to 3 mol % to less than or equal to 7 mol %, from greater than or equal to 4 mol % to less than or equal to 6 mol %, 5 mol %, or any range formed from any two of the foregoing values.

In some aspects, the hydrogen species does not diffuse to the center of the glass-based article as a result of the steam treatment, and the interior material at or near the center of the glass-based article may have a composition that is unmodified (i.e., substantially the same, or the same, as the composition of the glass-based substrate prior to the steam treatment).

The glass-based articles disclosed herein may be incorporated into another article such as an article with a display, including but not limited to mobile phones, tablets, computers, navigation systems, wearable devices, other consumer electronics, architectural articles, transportation articles used in vehicles (e.g., automotive, trains, aircraft, sea craft), appliance articles, or any article that requires some transparency, scratch-resistance, abrasion resistance, or any combination thereof.

### Example 1

In one example of the present disclosure, laser nano-perforation is performed on a glass-based substrate (i.e., a glass sheet) followed by steam treatment resulting in an intermediate article comprising an intact sheet of a glass-based material having laser nano-perforated contours and one or more compressive layers, including a lateral compressive layer. Optionally, the intermediate article is treated with one or more surface treatments to deposit an ink, dielectric coating, anti-reflective layer, or polymer, on the exterior surfaces of the sheet. The treated glass-based substrate is separated along the contours formed by the perforations to yield glass parts with strengthened edges as a result of the combination of the nano-perforation process with the steam treatment.

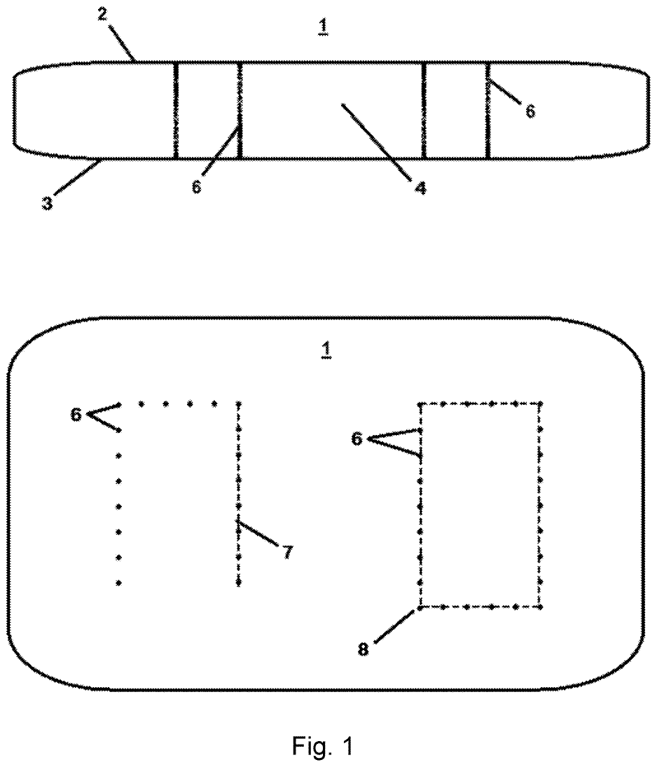

FIG. 1 schematically shows a side view (top) and top view (bottom) of a glass-based substrate 1 in this process having a plurality of perforations 6 extending from the first surface 2 of the substrate 1 through the interior 4 to the second surface 3. The perforations 6 are formed close enough together so that cracks form between the perforations 6 and form the contour lines 7, such as a closed contour 8 that defines the perimeter of the article to be made.

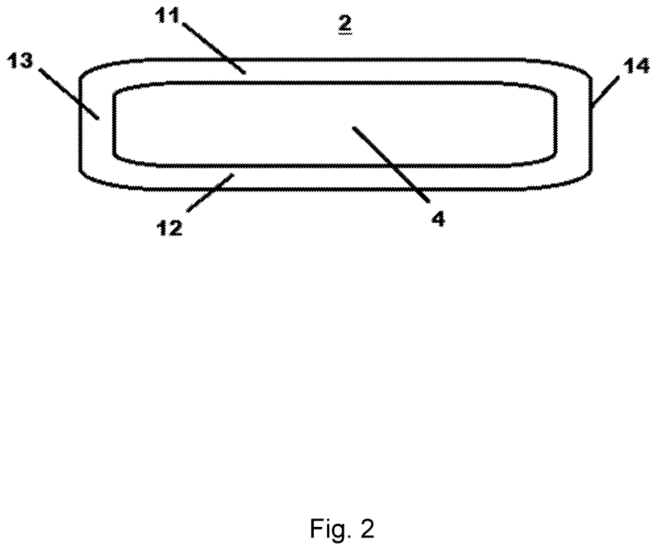

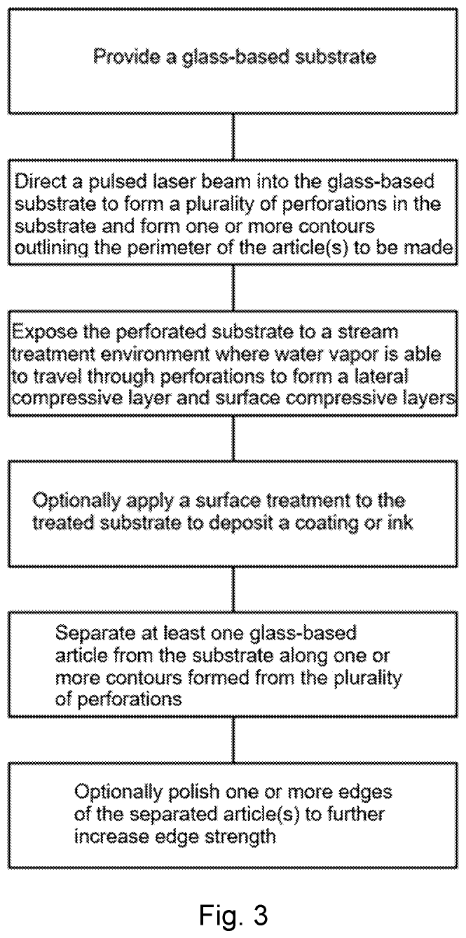

FIG. 2 shows a side view schematic of a glass-based article 2 formed from the substrate 1 in FIG. 1 after undergoing a steam treatment and separation. The article has a first compressive layer 11 extending from the first surface 2 (see FIG. 1) toward the interior 4, a second compressive layer 12 extending from the second surface 3 (see FIG. 1) toward the interior 4, and a lateral compressive layer 13 extends through the interior 4 of the article 2 at the locations of the laser nano-perforations 6 (seen in FIG. 1), which now form the outer edges of the separated glass based article. The compressive layers 11, 12 and 13 have increased hydrogen concentration. Optionally, the article 2 is polished along one or more of the edges 14 in order to further enhance edge strength by removing residual flaws (by removing a few or more micrometers of material) or to add an edge chamfer. FIG. 3 is a flow chart of the process described above for forming the glass-based article having strengthened edges.

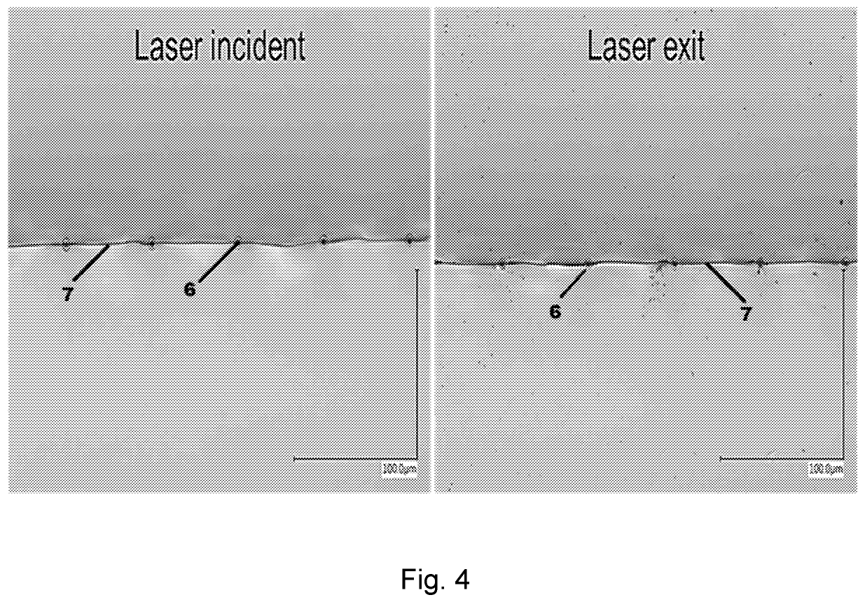

FIG. 4 shows optical images of a steam strengthened glass sheet after a laser perforation process (formed using a Bessel laser) was used to form multiple micrometer sized nano-perforations in a glass sheet and prior to separation. The laser incident surface is shown in the left panel, and the laser exit surface is shown in the right panel. Cracks between perforations 6 form along the contour line 7 defined by the perforations.

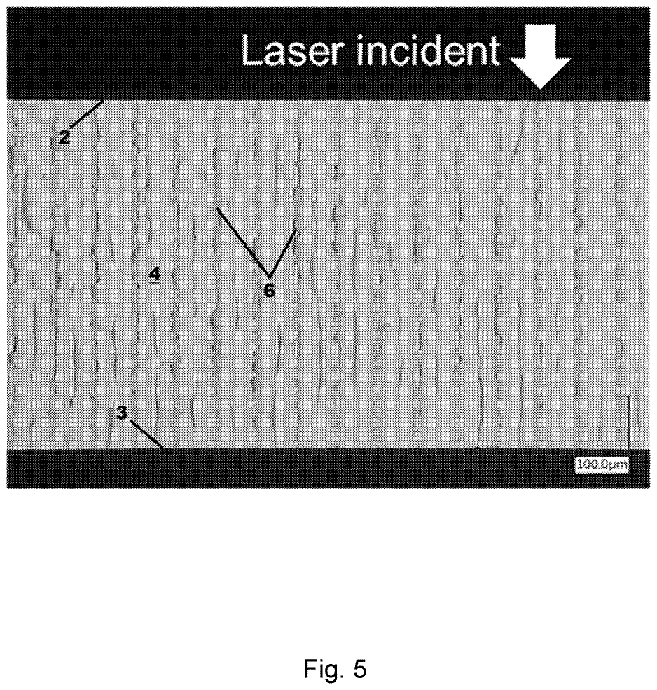

The glass edge after separation is shown in the optical images in FIG. 5, where the arrow indicates the surface on which the laser was incident. The nano-perforations 6 are seen as the dark columns extending through the entire interior 4 of the glass sheet from the first surface 2 to the second surface 3 (see FIG. 1).

Glass-based articles having the hydrogen enriched surface and edges result in compressive stress along the surfaces as well as the edges that resists impact damage. Optionally, to further enhance the edge strength, the same article may have polished edges, for example processed with a brush polish process, where some DOL/hydrogen concentration is removed along the edge along with defects and flaws. The DOL, while reduced in depth along the edge after such polishing, is still present along all exterior faces of the article. The hydrogen enrichment and depth-of-layer of compressive stress on the edges is less than on the top/bottom surface of the glass-based article, which is a signature that material has been removed (e.g., via polishing) after steam treatment. Optionally, the resulting article is further processed to have slightly radiused or chamfered corners where the top or bottom of the parts meet the edge of the part, and in some aspects has a surface finish along the edge of the part with an Ra less than or equal to 20 nm.

Advantages of the processes described in these examples include lower cost of manufacturing and more environmentally friendly manufacturing by using steam instead of ionic salt baths used in IOX methods. Additionally, laser processing of the glass-based substrate to form perforations in the substrate prior to the steam treatment creates strengthened edges not available in methods where perforations are not utilized. The present methods also provide lower costs to process full sheets using the steam strengthening treatment and optional surface treatments rather than parts treating individual parts. Coatings can also be applied before the laser and stream treatment, which simplifies alignment between coating and laser cutting, and minimizes concern of “pop-out” of internal parts, which may complicate coating process. Additionally, less removal of material is required to enhance edge strength during polishing.

### Example 2

Four different process flows were evaluated to quantify the impact of steam treatment on edge strength:
1. Standard glass cutting process: formation of nano-perforations followed by separation of the articles from the glass sheet (no steam treatment was performed).
2. Steam treatment of the glass sheet then cut: steam treatment followed by formation of the nano-particles, followed by separation of the glass articles from the sheet (surfaces were strengthened but the edges were not strengthened).
3. Steam treatment at the part level: formation of nano-perforations followed by separation of the articles from the glass sheet followed by steam treatment.
4. Steam treatment of nano-perforated glass sheet: formation of nano-perforations in the sheet followed by steam treatment followed by separation of the articles from the glass sheet (strengthened edges).

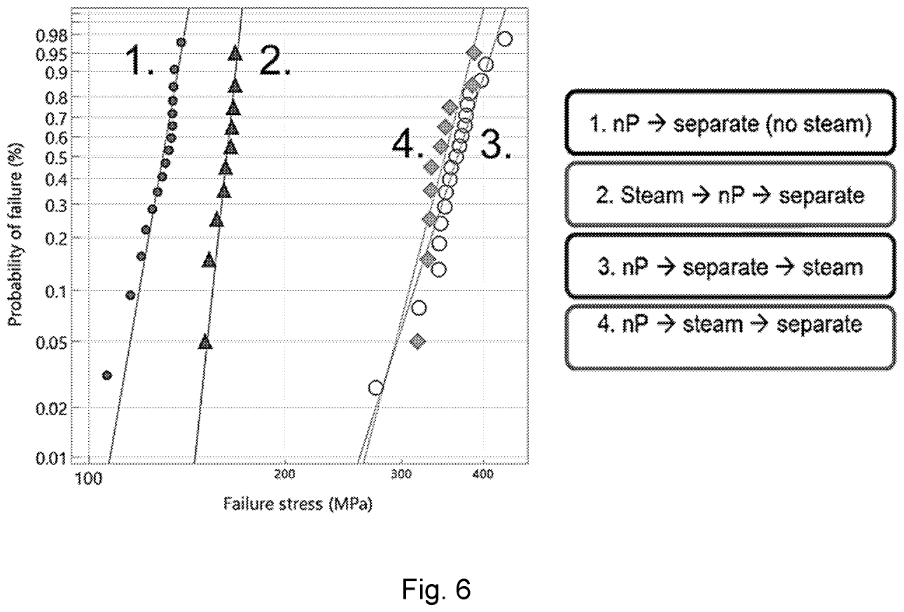

The edge strength was not fully optimized for these experiments, as this was meant only as a comparison study between the 4 different approaches. 100×100 mm sheets of 0.6 mm thick fusion formed steam strengthenable glass were used to create 60×44 mm samples for 4-point bend reliability measurements. Reliability results are shown in FIG. 6. Process 1, which has just the non-strengthened material, exhibited an edge strength B10 value of approximately 120 MPa, where B10 is the stress value above which at least 10% of the tested parts have failed. There was some improvement in the edge strength between process 1 and process 2, with a B10 increase to 150 MPa, which may be attributed to the steam treatment creating a compressive layer near the top and bottom surface of the articles, although the majority of the cut edge from process 2 would not be expected to be under compression.

There was further improvement when using processes 3 and 4 (formation of nano-perforations followed by a steam treatment), both of which had a B10 of 300 MPa. The improvements of process 4 can be explained by the water vapor from the steam treatment penetrating into the perforations and strengthening the regions of the glass sheet that become the edges of the articles. There was no significant difference between the strengths of parts made with process 3 and 4, indicating that process 4's steam treatment at the nano-perforated sheet level provides strengthening that is equivalent to steam treating articles at the part level. In this regard, it is generally much easier and more efficient to treat the glass sheet as a whole compared to individual separated parts. The distribution of edge strength results exhibits low variability (a steep probability curve), which is a characteristic of the consistent flaw size generated by the laser nano-perforation process. The data was collected by testing both laser incident and laser exit sides in compression to failure.

These results show there is strengthening of the laser created edge, such as through diffusion of water into the laser nano-perforation or cracks that is/are formed. Thus the edge strength of the separated article was enhanced after steam treatment and separation according to the aspects of the present disclosure.

Temperature, vapor pressure, and duration can be adjusted to change the depth of layer (DOL) and compressive stress (CS) of the final glass. The steam treatment condition used in the experiments of FIG. 6 was 300 °C, 1.37 MPa vapor pressure (water partial pressure), and 24 hours treatment duration. The DOL of the compressive layers was 45 μm and CS was 170 MPa. Another steam treatment condition tested used a temperature of 300 °C, 0.86 MPa vapor pressure (water partial pressure), and 3.75 hours treatment duration. In this experiment, the DOL of the compressive layers was 20 μm and CS was 200 MPa, and the results from process 3 and 4 are similar as what is shown in FIG. 6.

The laser nano-perforation process used in this example was not optimized for maximum strength (e.g. to minimize flaws size) and is just one example of what could be used for this process. To make these nano-perforations, a 1064 nm PicoBlade 3 laser with ~12 picosecond pulse duration was operated at 100 kHz repetition rate in burst mode, with 10 pulses within a burst and 24 nanosecond delay between pulses, and 1 mJ of burst energy.

Optics were used to form the above laser beam into a Bessel beam with 2.0 mm full-width-at-half-maximum line length and 1.35 μm core radius (radius of first null in Bessel function), which was used to create the nano-perforations in the glass sheet with a nP-to-nP pitch (space between adjacent perforations) of 60 μm. Those experienced in the art of laser processing will recognize that a large parameter space exists that can create nP with cracks connecting by adjusting laser wavelength, repetition rate, burst profile, pulse intensity, pitch, Bessel beam size, etc.

Additional strength improvements can be achieved with fine mechanical-polishing, such as brush polishing. The increase in strength is due to the removal of the laser induced flaws by the polish process. Of course, this process step results in less depth of layer (DOL) of hydrogen penetration along the edge than before polishing, as there is some material removal. However, there would still be a signature hydrogen-containing layer at the edge. There also could be slightly radiused or chamfered corners imparted, and a surface finish along the edge of the parts with an Ra<=100 nm, more frequently <20 nm.

### Example 3

This example demonstrates the formation and measurement of a hydrogen enrichment layer after performing steam treatment on a perforated glass-based article, followed by singulation along the perforations.

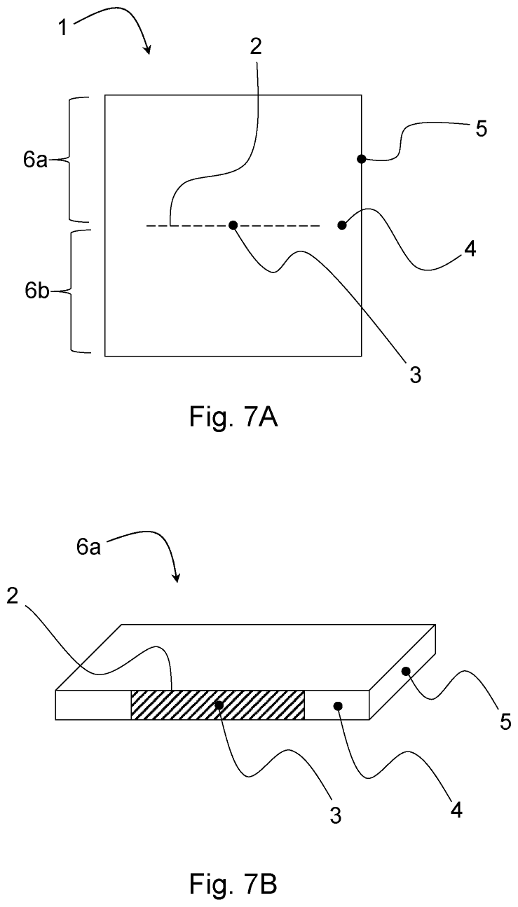

A glass-based article was prepared using the same laser and steam treatment conditions of Example 2. In particular, as shown in FIG. 7A, a glass-based substrate was perforated to create perforations 2 using a laser. The perforated glass-based substrate was then steam treated to form a glass-based article. The steam-treated glass-based article was then broken along the perforations to form two pieces: 6a and 6b. FIG. 7B shows a profile view of the piece 6a singulated from glass-based article 1 in FIG. 7A. As shown in FIG. 7B, the edge of the piece indicated as feature 2 derived from perforation line 2 in FIG. 7A. Features 3, 4, and 5 also indicate corresponding locations in glass-based article 1 compared to piece 6a.

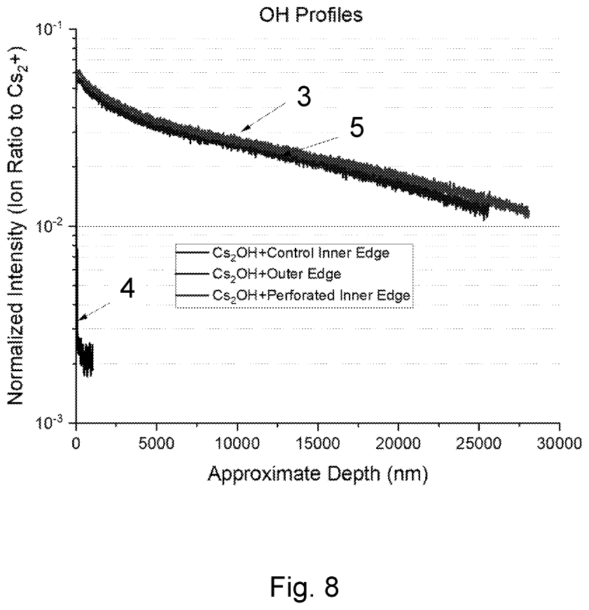

Secondary ion mass spectrometry (SIMS) analysis was performed to determine hydrogen enrichment, with the SIMS data shown in FIG. 8. As indicated in FIG. 8, there is significant (<25 μm depth) hydrogen enrichment in regions 3 and 5. Enrichment was essentially not discernable between regions 3 and 5, indicating equivalent enrichment between the steam exposed edge and the nano-perforated region. In other words, steam infiltrated the perforations just as effectively as at the edge of the article. There was minimal hydrogen enrichment (~50 nm) present in region B, which is not surprising given that there are no perforations in that region.

The SIMS measurements were performed as follows. The steam-treated glass-based article in FIG. 7A was broken along the perforations at the time of the analysis and placed into the SIMS instrument's vacuum chamber. The singulated piece was affixed to an appropriate apparatus for a cross-sectional view of the article along the nano-perforated edge, cleaved edge, and native edge as the target for the ion optical path. Depth profiles were acquired from this orientation to obtain a relative concentration profile for hydrogen as a function of depth from this surface (the edge, on the face perpendicular to the primary surface). Data was taken from regions 5 and 3 about 125 μm from the top edge, while data was taken from region 4 about 100 μm from the top edge.

SIMS was conducted using a time-of-flight secondary ion mass spectrometer (ToF-SIMS) with a dual beam configuration. The ToF-SIMS used for the results reported herein was a ToF-SIMS M6 instrument (available from IONTOF GmbH) equipped with a Nanoprobe50 bismuth source. The TOF-SIMS M6 instrument was operated with a dual-beam configuration, where the analysis beam was a 30 kilo-electronVolts (keV) Bi₃⁺ beam with a current of about 0.1 pA and the sputter beam was 2 keV Cs⁺ with a current of about 120 nA. The sputter beam was configured from a 250 μm by 250 μm sputter “crater,” and the analysis beam was configured to impinge a 50 μm by 50 μm area centered in the sputter “crater.” Charge compensation was achieved using an electron flood gun operating with 20 μA beam current, 20 eV electron energy, and a 1.5 mm spot size focused on the location impinged by the analysis beam. The chamber was evacuated to a pressure of approximately 5×10⁻⁷ Pascals (5×10⁻⁹ millibar) before being brought to and maintained at a pressure of 6×10⁻⁵ Pascals (6×10⁻⁷ millibar) using argon (e.g., 99.99999% purity). Data was collected in positive ion mode with the analyzer in the “all purpose” mode, an analyzer energy of 3000 V and a cycle time of 100 microseconds. Data was acquired in a non-interlaced 3D measurement mode with an integer number of frames per cycle to have a sequence of approximately 1 second each for analysis, sputtering, and wait time. Data was processed using Surface Lab software (available from IONTOF GmbH). To obtain relative depth vs concentration profiles for hydrogen, Cs₂OH⁺ was used to represent the total hydrogen within the subsurface of the glass, and depth scales were calibrated by measuring the final depth of sputter craters with a stylus profilometer. A normalized intensity was defined as the ratio of the ion signal divided by the Cs₂⁺ ion signal in each individual analysis cycle.

Having now fully described the present invention in some detail by way of illustration and examples for purposes of clarity of understanding, it will be obvious to one of ordinary skill in the art that the same can be performed by modifying or changing aspects of the disclosure within a wide and equivalent range of conditions, formulations and other parameters without affecting the scope of the invention or any specific aspect thereof, and that such modifications or changes are intended to be encompassed within the scope of the appended claims.

When a group of materials, compositions, components or compounds is disclosed herein, it is understood that all individual members of those groups and all subgroups thereof are disclosed separately. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. Additionally, the end points in a given range are to be included within the range. In the disclosure and the claims, “and/or” means additionally or alternatively. Moreover, any use of a term in the singular also encompasses plural forms.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements.

Directional terms as used herein, such as up, down, right, left, front, back, top, bottom, are made only with reference to the figures as drawn and are not intended to imply absolute orientation.

One of ordinary skill in the art will appreciate that starting materials, device elements, analytical methods, mixtures and combinations of components other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. The invention illustratively described herein suitably may be practiced in the absence of any element or elements, limitation or limitations which is not specifically disclosed herein. Headings are used herein for convenience only.

All publications referred to herein are incorporated by reference herein to the extent not inconsistent herewith. Some references provided herein are incorporated by reference to provide details of additional uses of the disclosure. All patents and publications mentioned in the specification are indicative of the levels of skill of those skilled in the art to which the invention pertains. References cited herein are incorporated by reference herein in their entirety to indicate the state of the art as of their filing date and it is intended that this information can be employed herein, if needed, for any purpose, such as to include or exclude specific aspects that are in the prior art.

What is claimed is:

1. A glass-based article comprising:
a first surface and a second surface, wherein the second surface is positioned opposite to the first surface and defines an interior comprising a glass or glass-based material;
a plurality of perforations that extend in a first direction from the first surface toward the second surface and through at least a portion of the interior, wherein each perforation comprises a volume of the glass or glass-based material having a plurality of voids and/or micro-fissures, and wherein the plurality of perforations form one or more contour lines in at least one of the first and second surfaces;
a first compressive layer extending from the first surface toward the second surface;
a second compressive layer extending from the second surface toward the first surface; and
a lateral compressive layer extending in a second direction from each of the perforations within the interior, wherein the first, second, and lateral compressive layers each comprise an increased hydrogen concentration compared to a concentration of the interior at a midpoint between the first and second surfaces.

2. The article of claim 1, wherein at least a portion of the plurality of perforations extend from the first surface to the second surface.

3. The article of claim 1, wherein the one or more contour lines form a closed contour.

4. The article of claim 1, wherein the first compressive layer has a first depth of layer (DOL₁) between 10 μm and 150 μm, the second compressive layer has a second depth of layer (DOL₂) between 10 μm and 150 μm, and the lateral compressive layer has a lateral depth of layer (DOL_{L}) between 10 μm and 150 μm.

5. The article of claim 1, further comprising a coating disposed on an exterior of the first surface, second surface, or both, wherein the coating comprises an ink, a dielectric coating, an anti-reflective layer, a polymer, or any combination thereof.

6. The article of claim 1, wherein perforations along the one or more contour lines are spaced apart from adjacent perforations by a distance between 1 μm and 100 μm.

7. The article of claim 1, comprising a glass-based composition comprising greater than or equal to 50 mol % and less than or equal to 70 mol % SiO₂; greater than or equal to 5 mol % and less than or equal to 20 mol % Al₂O₃; greater than or equal to 1 mol % and less than or equal to 9 mol % P₂O₅; greater than or equal to 1 mol % and less than or equal to 20 mol % Na₂O; and greater than or equal to 1 mol % and less than or equal to 10 mol % K₂O.

8. A method for forming a glass-based article comprising the steps of:
a) forming a plurality of perforations in a glass-based substrate having a first surface and a second surface, wherein the second surface is positioned opposite to the first surface and defines an interior comprising a glass or glass-based material, wherein the plurality of perforations extend in a first direction from the first surface toward the second surface through at least a portion of the interior, wherein each perforation comprises a volume of the glass or glass-based material having a plurality of voids and/or micro-fissures, and wherein the perforations define the glass-based article;
b) exposing the first and second surfaces and the plurality of perforations of the perforated substrate to a treatment environment having a first pressure, first water partial pressure, and first temperature, thereby forming a treated substrate having a first compressive layer extending from the first surface toward the second surface, a second compressive layer extending from the second surface toward the first surface; and a lateral compressive layer extending in a second direction from each of the plurality of perforations into the interior,
wherein the first, second and lateral compressive layers each comprise an increased hydrogen concentration compared to a concentration of the interior at a midpoint between the first and second surfaces.

9. The method of claim 8 further comprising separating the glass-based article from the treated substrate along one or more contour lines formed by the plurality of perforations within the interior of the treated substrate, thereby generating edges at the one or more contour lines.

10. The method of claim 8, wherein the glass-based article is not subjected to conditions of the treatment environment after the separating.

11. The method of claim 8, wherein perforations along the one or more contour lines are spaced apart from adjacent perforations by a distance between 1 μm and 100 μm.

12. The method of claim 8, wherein forming the plurality of perforations in the glass-based substrate comprises directing a laser beam along a beam pathway into the glass-based substrate and generating an induced absorption within the glass-based substrate, the induced absorption producing a plurality of voids and/or micro-fissures within the glass-based substrate.

13. The method of claim 8, further comprising applying one or more surface treatments to the first surface, second surface, or both, after exposing the perforated substrate to the treatment environment and prior to separating the glass-based article from the treated substrate, wherein applying one or more surface treatments comprises depositing an ink, dielectric coating, anti-reflective layer, or polymer, on an exterior of the first surface, second surface, or both.

14. The method of claim 8, wherein at least one of the following is satisfied:
the first pressure of the treatment environment is greater or equal to 0.8 MPa and less than or equal to 9 MPa;
the first partial water pressure of the treatment environment is greater than or equal to 0.05 MPa and less than or equal to 22.0 MPa;
the first temperature of the treatment environment is greater than or equal to 200 °C and less than or equal to 300 °C;
the perforated substrate is exposed to the treatment environment for greater than or equal to 2 hours and less than or equal to 100 hours;
the treatment environment comprises a relative humidity of greater than or equal to 75%.

15. The method of claim 9, wherein the glass edge exhibits a failure stress with a B10 value greater than 200 MPa when tested for mechanical edge strength using a four-point bend test in accordance with ASTM C158-02.

16. The glass-based article produced by the method of claim 8.

17. A glass-based article comprising:
a first surface and a second surface, wherein the second surface is positioned opposite to the first surface;
one or more exterior edges extending between the first surface and the second surface, wherein the first and second surfaces and the one or more exterior edges defines an interior comprising a glass or glass-based material;
a first compressive layer extending from the first surface toward the second surface, a second compressive layer extending from the second surface toward the first surface, and a lateral compressive layer extending from the one or more exterior edges toward the interior,
wherein the first, second, and lateral compressive layers each comprise an increased hydrogen concentration compared to a concentration of the interior at a midpoint between the first and second surfaces, and
wherein the first compressive layer has a first depth of layer (DOL₁) between 5 μm and 250 μm, the second compressive layer has a second depth of layer (DOL₂) between 5 μm and 250 μm, and the lateral compressive layer has a lateral depth of layer (DOL_{L}) between 5 μm and 250 μm.

18. The article of claim 17, wherein the first compressive layer has a first depth of layer (DOL₁) between 10 μm and 150 μm, the second compressive layer has a second depth of layer (DOL₂) between 10 μm and 150 μm, and the lateral compressive layer has a lateral depth of layer (DOL_{L}) between 10 μm and 150 μm.

19. The article of claim 17, wherein at least one of the exterior edges is a polished edge and wherein the lateral compressive layer has a lateral depth of layer (DOL_{L}) that is at between 5 μm to 100 μm less than the first depth of layer (DOL₁) and the second depth of layer (DOL₂).

20. The article of claim 17, comprising a glass-based composition comprising greater than or equal to 50 mol % and less than or equal to 70 mol % SiO₂; greater than or equal to 5 mol % and less than or equal to 20 mol % Al₂O₃; greater than or equal to 1 mol % and less than or equal to 9 mol % P₂O₅; greater than or equal to 1 mol % and less than or equal to 20 mol % Na₂O; and greater than or equal to 1 mol % and less than or equal to 10 mol % K₂O.
